(19) United States
(12) Patent Application Publication
(10) Pub. No.: US 2012/0261235 A1
(43) Pub. Date: Oct. 18, 2012

(54) APPARATUS FOR RECOVERING PIECES OF PASTE MADE OF ACTIVE MATTER FOR PLATES OF LEAD ACCUMULATORS

(75) Inventor: Pietro FARINA, Villafranca (IT)

(73) Assignee: SOVEMA S.p.A, Villafranca (IT)

(21) Appl. No.: 13/443,213

(22) Filed: Apr. 10, 2012

Related U.S. Application Data
(63) Continuation-in-part of application No. 13/079,325, filed on Apr. 4, 2011.

(30) Foreign Application Priority Data
Apr. 2, 2010 (IT) PD2010A000107

(51) Int. Cl. B65G 15/14

(52) U.S. Cl. 198/605

(57) ABSTRACT

Apparatus for recovering pieces of paste made of active matter for plates of lead accumulators, which comprises a first conveyor belt, having a first horizontal section for receiving the pieces from a spreading machine and a first vertical section, and a second conveyor belt, having a second horizontal section for transferring the pieces to the hopper of the spreading machine and a second substantially vertical section. The vertical sections are arranged counterfaced to each other to hold and transport the pieces interposed therebetween. A third conveyor belt is suitable to receive the pieces from the second horizontal section and transfer them to the hopper. The two conveyor belts are wound on two return rollers in common delimiting the vertical sections, at least one of which is provided with an annular cavity, within which the conveyor belt can extend to house the lead pieces with the other belt superimposed.

### FIELD OF APPLICATION

The present invention concerns an apparatus for recovering pieces of paste made of active matter for plates of lead accumulators, according to the preamble of the main independent claim.

The apparatus in question is intended to be used in the industrial sector for the production of acid lead accumulators associated to a lead grid spreading machine with a paste made of active matter adapted for the formation of plates for electrical accumulators.

### STATE OF THE ART

The industrial system for producing lead accumulators conventionally provide for the use of spreading machines for distributing on one or on both the sides of lead alloy grids a paste made of active matter generally constituted by lead oxide, diluted sulphuric acid, water and additives.

Spreading machines, comprising a hopper for loading the active material to be spread, stiffing means mounted within the hopper for mixing and pressing the paste, and a spreading unit generally obtained by means of counter-rotating rollers adapted to forcedly emit through a fissure a continuous strip of paste made of active matter, above the grids which advance on a conveyor belt are known in the market.

Exiting from the abovementioned conveyor belt, while the grids are picked up, for example by a second conveyor belt, the pieces of paste made of active matter corresponding to the space that corresponds to the grids in succession on the conveyor belt are conveyed externally to the spreading machine for example by means of a chute towards a collection tank.

The pieces collected in the tank can be advantageously reused by reintroducing them into the hopper.

The transport of such pieces, i.e. ribbons or strips of paste made of active matter, from the exiting end of the conveyor belt up to the hopper, is currently carried out manually or automatically.

The manual transport of the pieces of paste made of active matter implies considerably high staff costs and the operation is quite laborious and complex.

The automatic transport of the pieces of paste has been obtained up to now apparatus for recovery thereof which revealed to be bulky and operatively poorly functional.

More in detail, a first apparatus for recovering pieces of paste for plates of lead accumulators, provides for the use of more inclined conveyor belts, which unload in succession one on the other the pieces oriented along a trajectory which starts from beneath the end of the conveyor belt and ends above the hopper.

Such apparatus, of the known type, revealed to be extremely bulky requiring the use of several inclined conveyor belts operatively connected in series to each other. Furthermore, the pieces simply resting on the belts can easily fall, in particular at the jumps between a belt and the other.

A second apparatus provides for picking up, with an auger operating intermittently, the pieces that accumulate in preset time intervals in the collection tank, and transferring them by means of several augers in succession, only one of which vertical, up to the loading opening of the hopper.

This apparatus revealed to be expensive to construct and operatively unsuitable for the transport of the pieces of paste made of active matter. Actually, the latter should maintain, during transport, the original density thereof so as to avoid creating problems related to uniformity and composition within the hopper. Otherwise, the above-mentioned augers compact the paste during transport varying the density thereof and hence immediately emit into the hopper, at each operating period thereof, particularly compact and thick cords of paste which then require compensation with special dilutions into the hopper making the system extremely complex and difficult to control.

### SPECIFICATION OF THE INVENTION

In this situation, the problem on which the present invention is based is that of overcoming the drawbacks revealed by the solutions of the prior art, by providing an apparatus for recovering pieces of paste made of active matter for plates of lead accumulators, capable of allowing an ideal transport of such pieces up to the opening of the a hopper of a spreading machine.

A further object of the present invention is that of providing an apparatus for recovering pieces of paste made of active matter for plates of lead accumulators, which allows transporting the abovementioned pieces substantially without modifying the density thereof.

Another object of the present invention is to provide an apparatus for recovering pieces of paste made of active matter, requiring small overall dimensions.

Another object of the present invention is to provide an apparatus for recovering pieces of paste made of active matter, capable of continuously supplying the hopper of a spreading machine.

Another object of the present invention is to provide an apparatus for recovering pieces of paste made of active matter, capable of transporting the pieces without losses.

A further object of the present invention is to provide an apparatus for recovering pieces of paste made of active matter, which is economically easy to construct and operatively entirely reliable.

The apparatus for recovering pieces of paste made of active matter, according to the present invention allows attaining the advantage of automatically recovering the pieces of a spreading machine without altering the characteristics thereof for a complete and immediate use.

### BRIEF DESCRIPTION OF THE DRAWINGS

The technical characteristics of the invention, according to the above-mentioned objects, are clearly observable from the contents of the claims outlined hereinafter and the advantages thereof shall be more apparent from the detailed description that follows, provided with reference to the attached drawings, which represent some embodiments thereof provided purely by way of example, wherein:

FIG. 1 shows a first perspective view of the apparatus for recovering pieces of paste made of active matter, subject of the present invention;

FIG. 2 shows a second perspective view of the apparatus subject of the present invention, operatively associated to a spreading machine;

FIG. 3 shows a rear view of the apparatus subject of the present invention, operatively associated to the spreading machine;

FIG. 4 shows a plan view of the apparatus subject of the present invention, operatively associated to the spreading machine;

FIG. 5 shows a front view of the apparatus subject of the present invention, operatively associated to the spreading machine, with some parts removed to better reveal the others;

FIG. 6 shows a cross-sectional perspective view carried out according to a median longitudinal plane of the apparatus subject of the present invention;

FIG. 7 shows a rear view of a variant embodiment of the apparatus subject of the present invention;

FIG. 8 shows a plan view of the apparatus of FIG. 7 with some parts removed to reveal the others better,

FIG. 9 shows a perspective view of a front portion of the apparatus of FIG. 7;

FIG. 10 shows a perspective view of the apparatus of FIG. 7.

FIG. 11 shows a cross-sectional lateral view carried out according to a median longitudinal plane of the apparatus of FIG. 7;

FIG. 12 shows a perspective view of a variant embodiment of the apparatus of the present invention;

FIG. 13 shows the machine of FIG. 12 with a safety panel removed to reveal the rollers for supporting the belt better;

FIG. 14 shows an enlarged detail of the machine of FIG. 12 regarding the rollers for the sliding of the belts;

FIG. 15 shows the machine of FIG. 12 in a different perspective view;

FIG. 16 shows the machine of FIG. 12 in a top view;

FIG. 17 shows the machine of FIG. 12 in a lateral view, a side having been removed and with some parts in sectional view carried out along the line XVII-XVII of FIG. 16.

### DETAILED DESCRIPTION OF A PREFERRED EMBODIMENT

With reference to the attached drawings an apparatus for recovering pieces of paste made of active matter for plates of lead accumulators, subject of the present invention was indicated in its entirety with 1.

The abovementioned apparatus 1 for recovering pieces of paste made of active matter for plates of lead accumulators is intended to be operatively associated to a grid spreading machine 2. The grids, once spread with the paste made of active matter on one side or on both sides, form plates for the accumulators.

The apparatus 1 is generally suitable to be used for recovering the pieces of paste made of active matter from any spreading machine 2, which requires picking up the pieces at an outlet section of the machine, in which the formed plates normally leave a conveyor belt, and take them to an inlet station of the paste, which usually and according to the embodiment illustrated in the attached figures is obtained with a hopper 3 for loading the paste.

More in detail, the spreading machine illustrated in the attached figures comprises a bearing structure 4 on which there is mounted a hopper 3 for loading the active material to be spread. Within the hopper 3 there are provided stirring means (not illustrated) for mixing and pressing the paste. In the lower part of the hopper 3 there is mounted a spreading unit, of the per se known type, which is generally obtained by means of two counter-rotating rollers (or similar systems) adapted to forcedly emit through a fissure a paste strip which is laterally limited in a precise width by means of special templates.

The machine 2 also comprises at least one driven conveyor belt 5, on which the grids to be spread rest horizontally in succession spaced from each other and preferably coupled laterally two by two. The conveyor belt 5 is provided, in at least one central section thereof, beneath the hopper to take the grids to transit beneath the fissure at the spreading unit. Special calibrating and finishing rollers are provided downstream of the fissure for compressing the layer of paste uniformly in the meshes of the alloy lead grids.

At such spreading unit, the paste is conveyed pressurized into the meshes of the grids remaining delimited between the templates within the lateral dimension of the frame of the grids in question. The single grids of the succession that advances on the conveyor belt are, as mentioned, separated from each other by means of a spacer gap, whose function is that of preventing the grids from being misaligned on the belt by touching each other, for example due to stresses to which they are subjected when passing beneath the conveying or calibrating rollers i.e. in the passage through the spreading unit.

Also the abovementioned spacer gaps provided for between the grids are thus covered by the continuous strip which is emitted by the fissure of the hopper. The calibrating and finishing rollers, arranged downstream of the spreading zone, substantially determine the cutting—by compressedng the upper surface of the grids—of the paste strip at the front and rear edges of each grid with the ensuing formation of the pieces in form ribbons of paste. The latter are thus arranged on the belt at the interspaces between the grids, i.e. before and after each grid, with respect to the direction of advancement X thereof on the conveyor belt 5.

Exiting from the abovementioned conveyor belt 5, while the grids are picked up for example by a second conveyor belt, the ribbons of paste made of active matter are detached from the belt 5 by means of a scraper and externally conveyed to the machine 2 for recovery thereof.

The spreading machine 2 can be easily adapted to spread grades of various shapes by replacing the templates for conveying the paste. Such operation requires previously lifting the hopper 3 to uncover the templates. The lifting of the hopper 3 is for example obtained by actuating a first hydraulic actuator 6, aimed at inclining one side of the hopper 3, which is, for such purpose, hinged to the base along one side thereof. After lifting the hopper 3 the templates can be replaced with other different dimensions before closing the hopper 3 again by actuating the first hydraulic actuator 6.

The pieces are thus in form of small ribbons of a paste generally containing lead oxides, diluted sulphuric acid, water and additives.

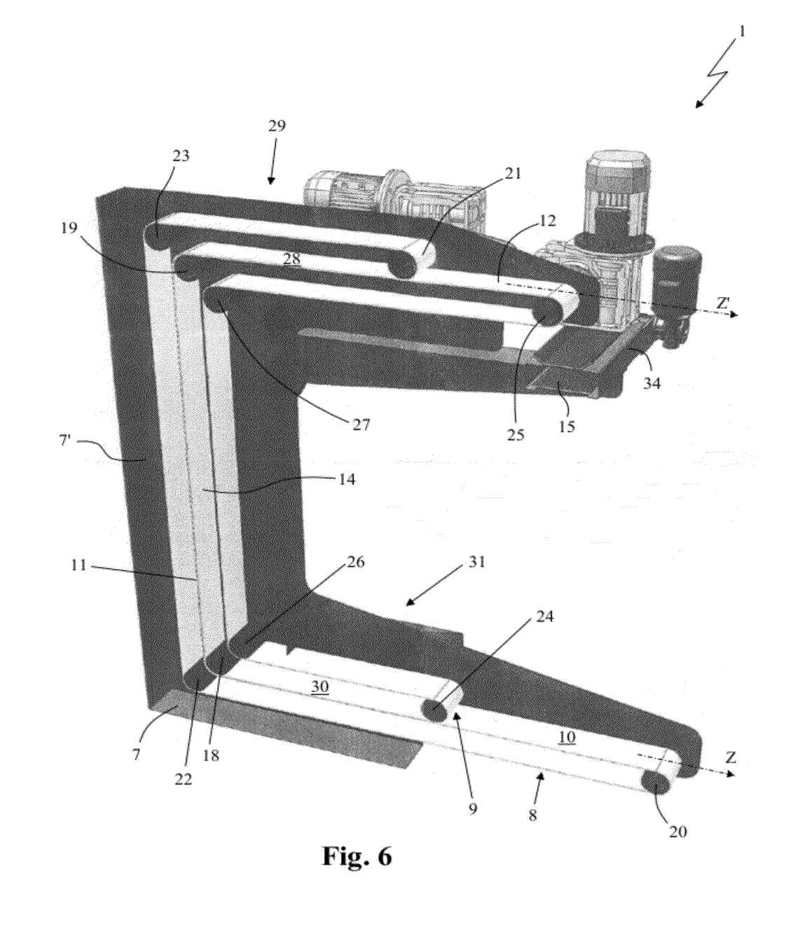

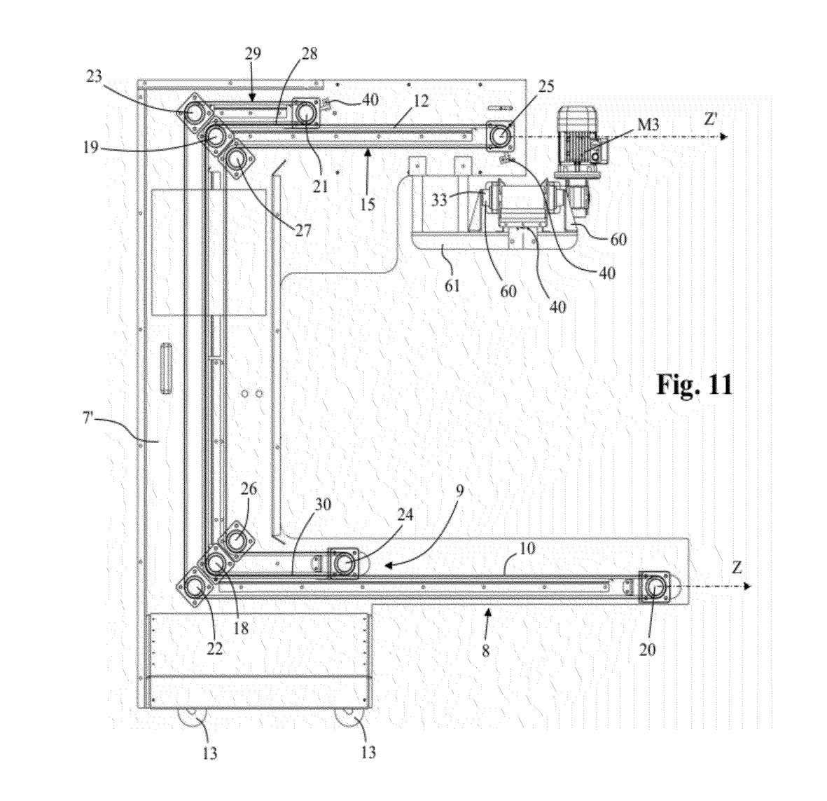

The apparatus 1 for recovering the pieces, subject of the present invention, comprises a support structure 7, which is intended to rest on the ground advantageously by means of wheels 13 for facilitating transport thereof, and it is substantially C-shaped, as easily observable from the attached FIGS. 6 and 11.

Two conveyor belts, respectively a first conveyor belt 8 and a second conveyor belt 9, which are wound in a loop on respective first and second rollers to be specified hereinafter are mounted on the support structure 7.

The first conveyor belt 8 is equipped with a first substantially horizontal section 10, which receives the pieces from the spreading machine 2, and with a first substantially vertical section 11 arranged to continue the first horizontal section thereof.

The second conveyor belt 9 is in turn equipped with a second substantially horizontal section 12, adapted to transfer the pieces, at a second end roller 25 thereof, and with a second substantially vertical section 14 arranged to continue the second horizontal section 12.

The horizontal sections 10 and 12 develop in preferably parallel directions indicated in the figures with Z and Z′.

The two vertical sections 11, 14 of the two conveyor belts 8, 9 are arranged one on the other counterfaced and parallel with respect to each other. They advance at the same speed so as to hold interposed, between the respective counterfaced surfaces, the pieces, taking them from the first horizontal section 10 of the first conveyor belt 8 and taking them to the second horizontal section 12 of the second conveyor belt 9.

According to the idea on which the present invention is based, the pieces are thus continuously taken from the first conveyor belt 8 as they fall from the belt 5 of the spreading machine 2, thus preventing dangerous accumulation thereof for the transport possibilities thereof. Furthermore, upon leaving the abovementioned first horizontal section 10 of the first conveyor belt 8, the pieces are taken over, without the possibility of falling, between the two vertical sections of the two belts 8, 9 that lift them to take them back substantially to the height of the opening for loading the hopper 3.

The abovementioned first and second vertical section 11 and 14 of the two conveyor belts 8 and 9 are wound on two return rollers in common, one of which is lower 18 and one is upper 19.

According to the present invention, at least one of the rollers in common 18, 19 is provided with an annular cavity 50, in which there can be extended at least the belt resting on the roller i.e. the second conveyor belt 9 resting on the rollers 18, 19, for housing the lead pieces with the belt resting thereon, i.e. the first belt 8.

Advantageously, both the lower 18 and upper 19 rollers are provided with such annular cavity 50, which is obtained by removing an intermediate portion thereof.

Thus, the lead pieces remain housed between the two conveyor belts 8 and 9 without being excessively compressed at the rollers in common 18, 19 and thus without the pieces being compressed and ejected outside the underlying space between the belts. Hence, the pieces of paste remain housed between the belts and they are driven by the advancement thereof along the path in which the two belts are coupled.

Thus, the apparatus 1 according to the invention provides for a third conveyor belt 15 wound in a loop on third rollers, arranged substantially transverse to the second horizontal section 12 of the second conveyor belt 9. The latter receive the pieces, in particular at a first end 16 thereof i.e. in a median section thereof, from the above-mentioned second horizontal section 12 and transfers them to the hopper 3 of the spreading machine 2 at the second end 17 thereof.

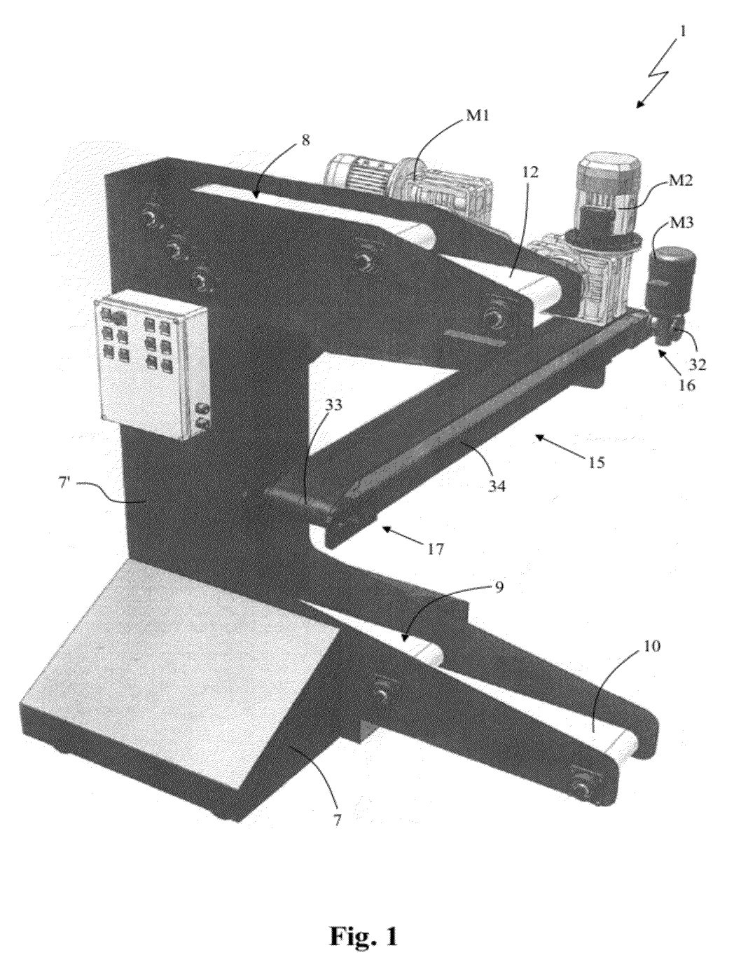

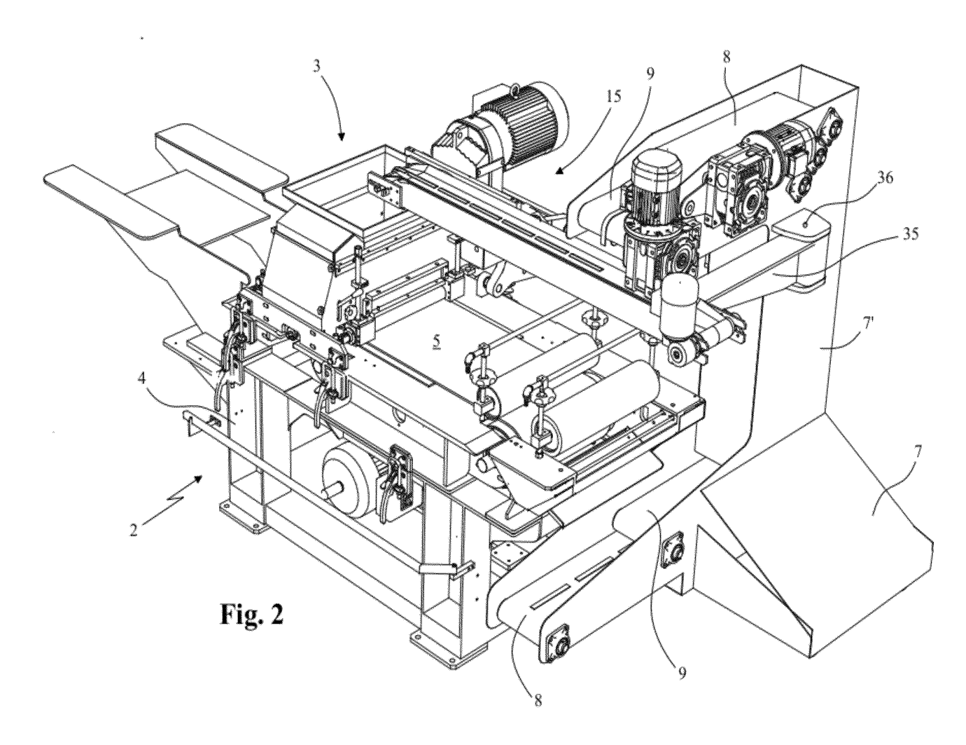

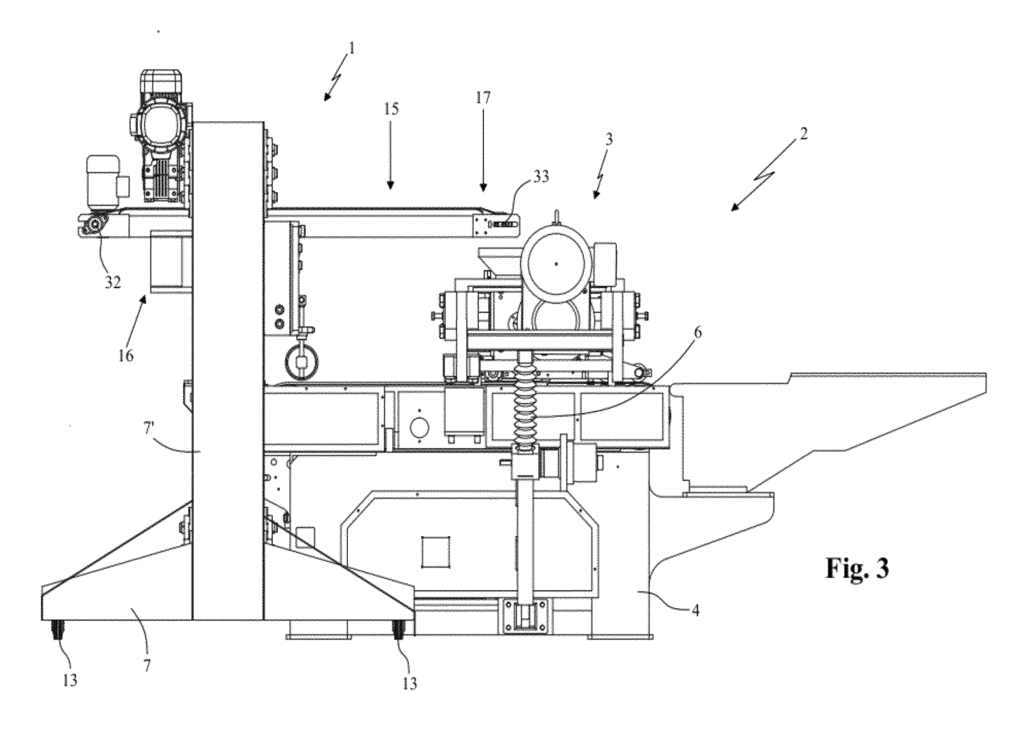

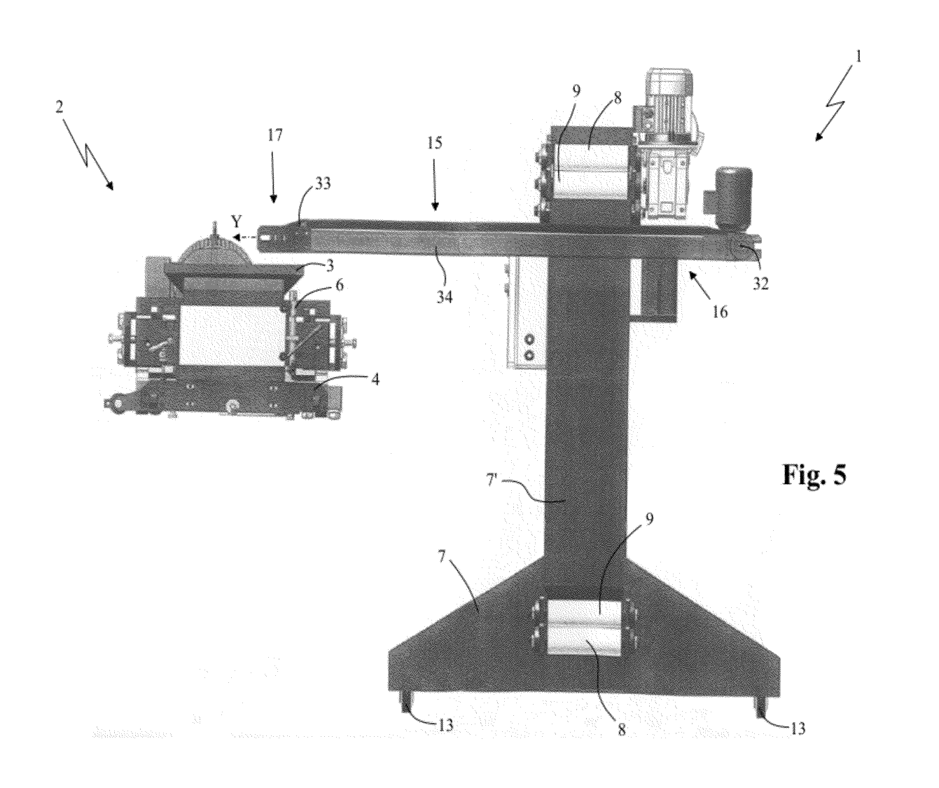

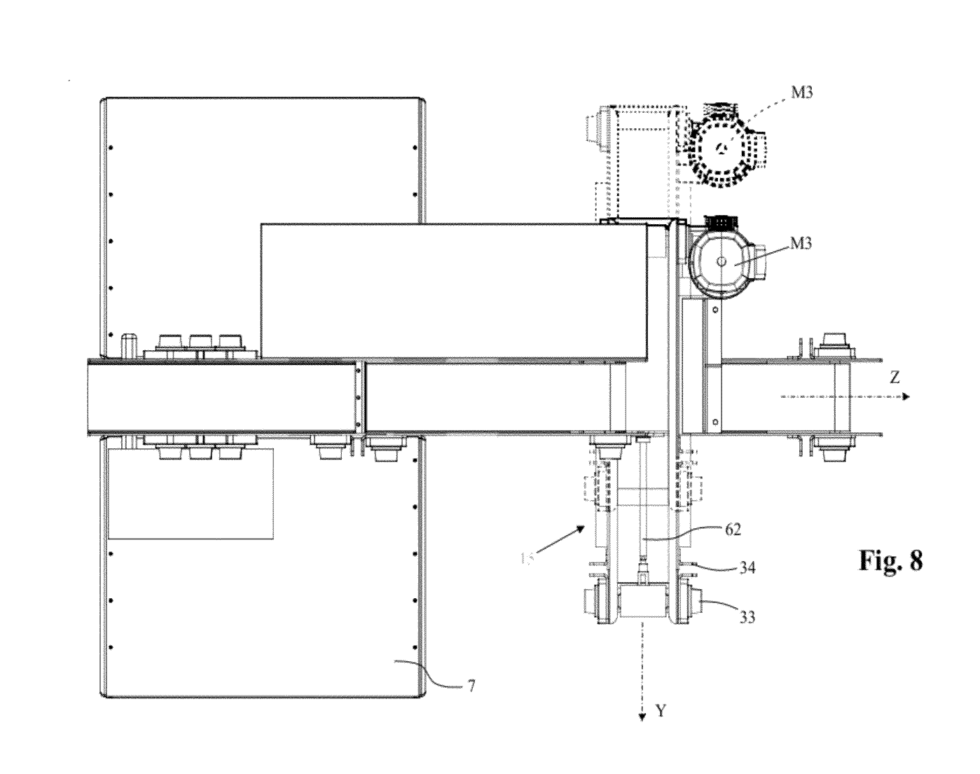

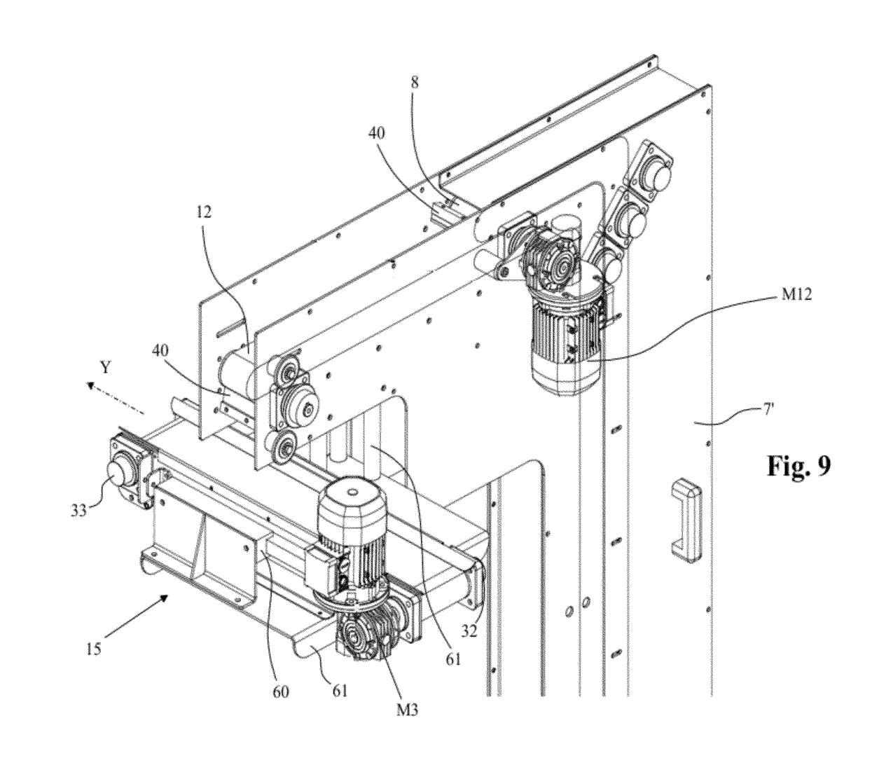

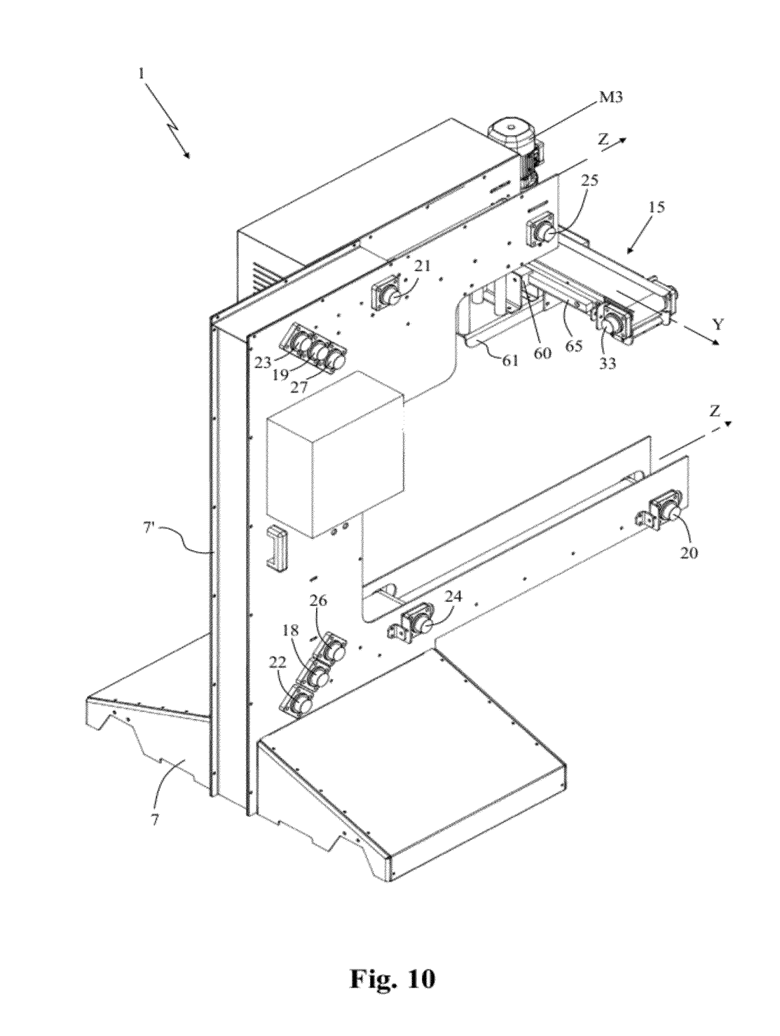

Preferably, according to the embodiments illustrated in the attached FIGS. 1-11 the two conveyor belts 8 and 9 develop, on all respective sides, parallel to each other so as to minimize the overall dimensions of the apparatus 1.

More in detail, the first conveyor belt 8 is wound in a loop, maintaining the belt on two parallel paths, on two first end rollers, one of which lower 20 and one upper 21, on the abovementioned first and second return roller 18, 19, and on a third and a fourth return roller 22, 23 arranged respectively at the height of the lower end roller 20 and the upper end roller 21 and respectively near the first 18 and the second 19 return roller.

The second conveyor belt 8 9 is in turn wound in a loop, maintaining the belt on two parallel paths, on two second end rollers, one of which lower 24 and one upper 25, on the abovementioned first and second return roller 18, 19, and on a fifth and a sixth return roller 26, 27 arranged respectively at the height of the lower end roller 24 and the upper end roller 25 and respectively near the first 18 and the second 19 return roller.

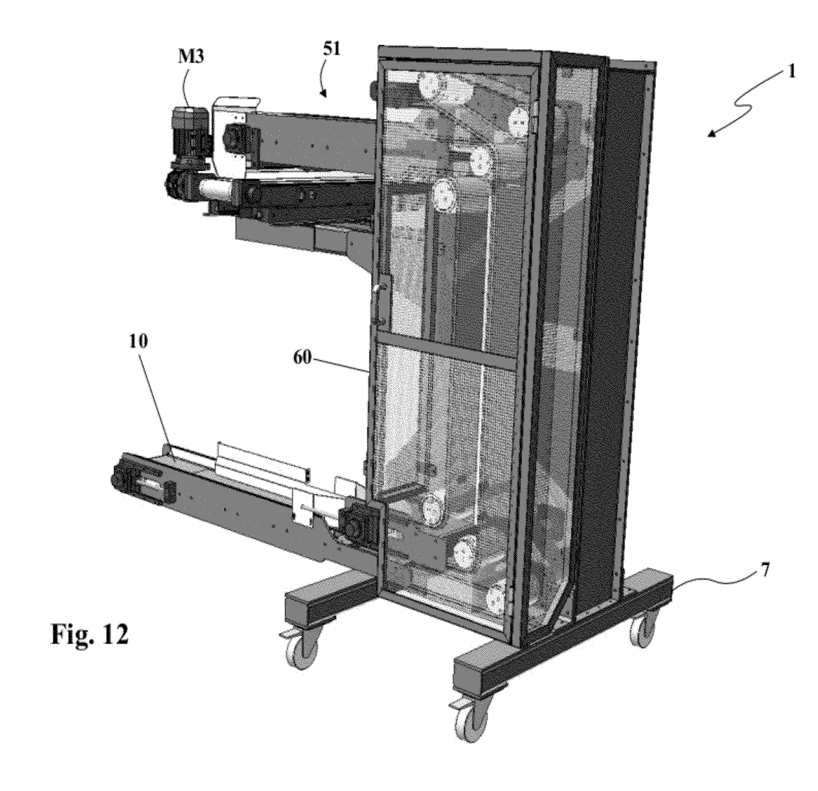

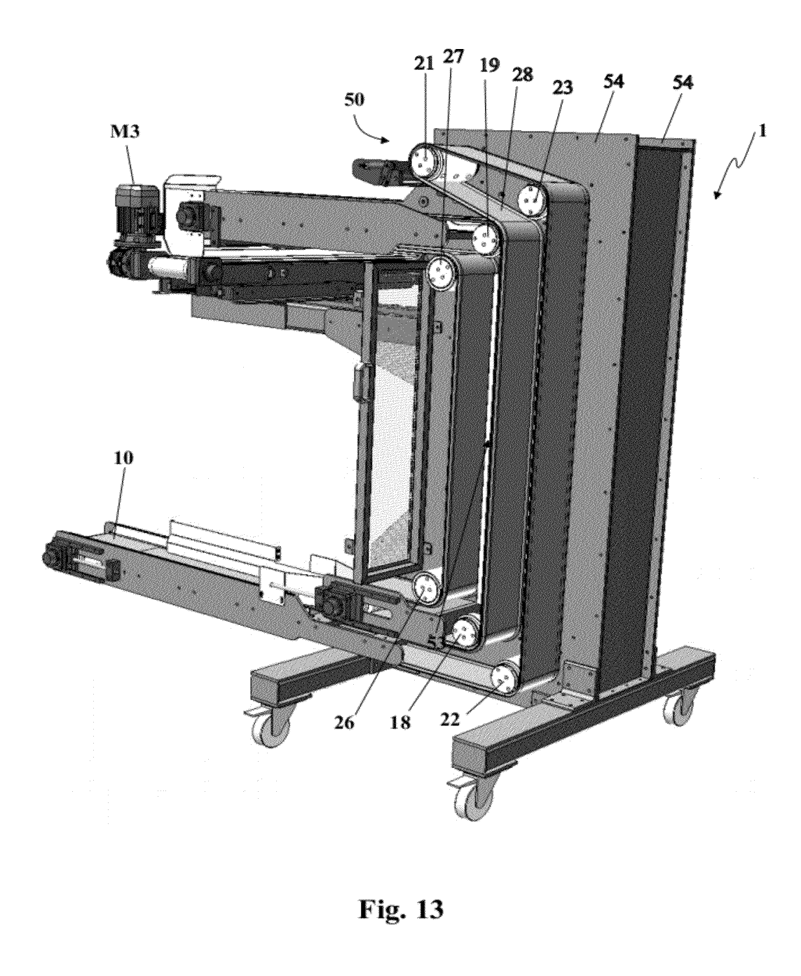

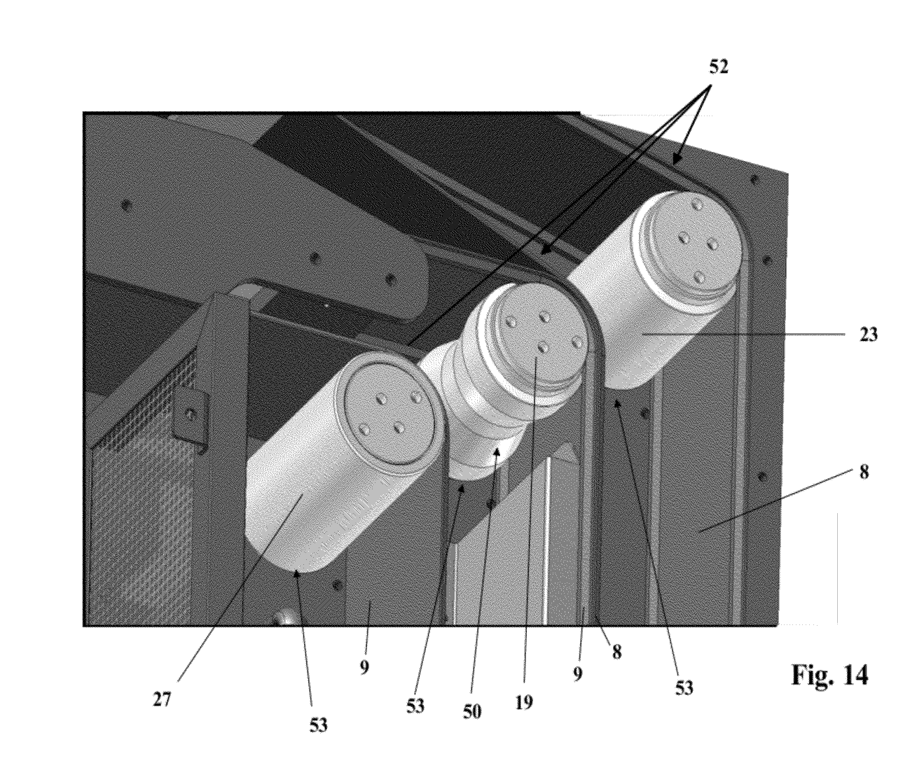

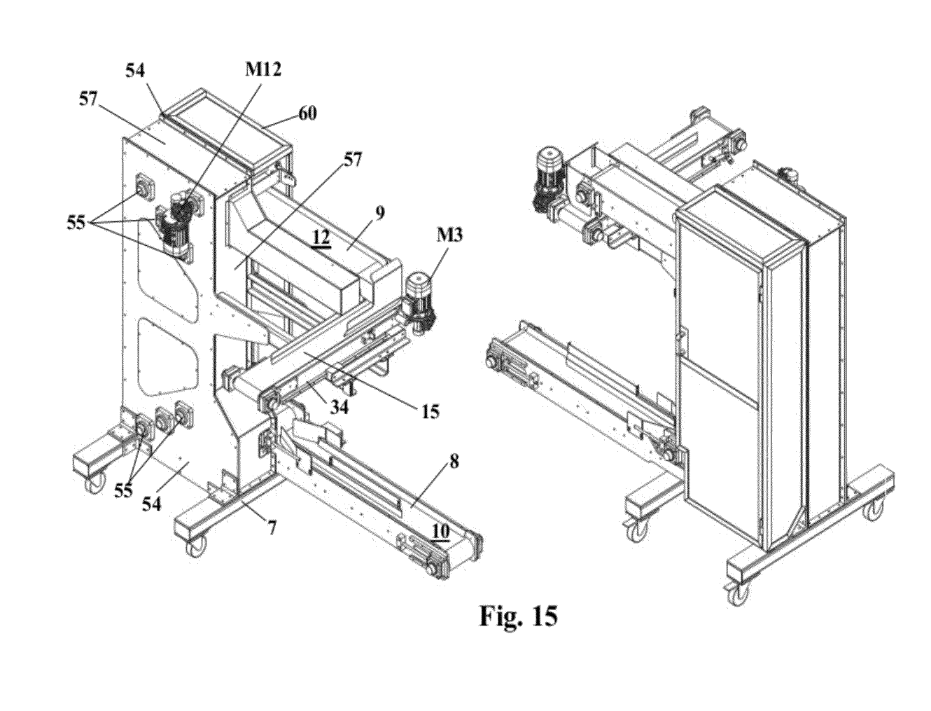

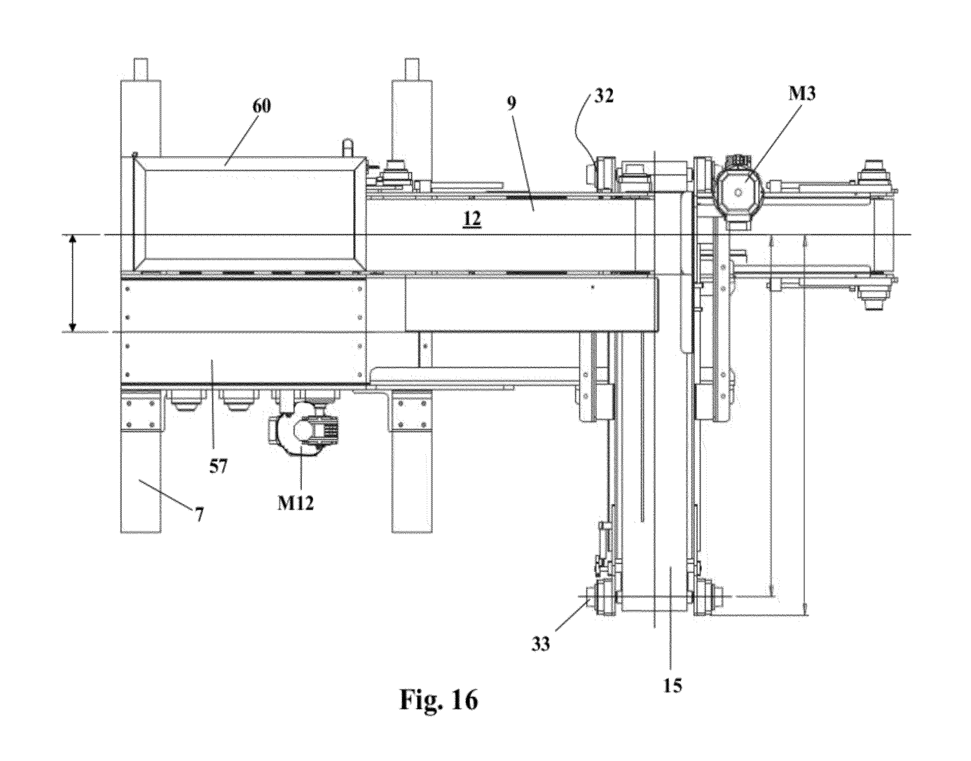

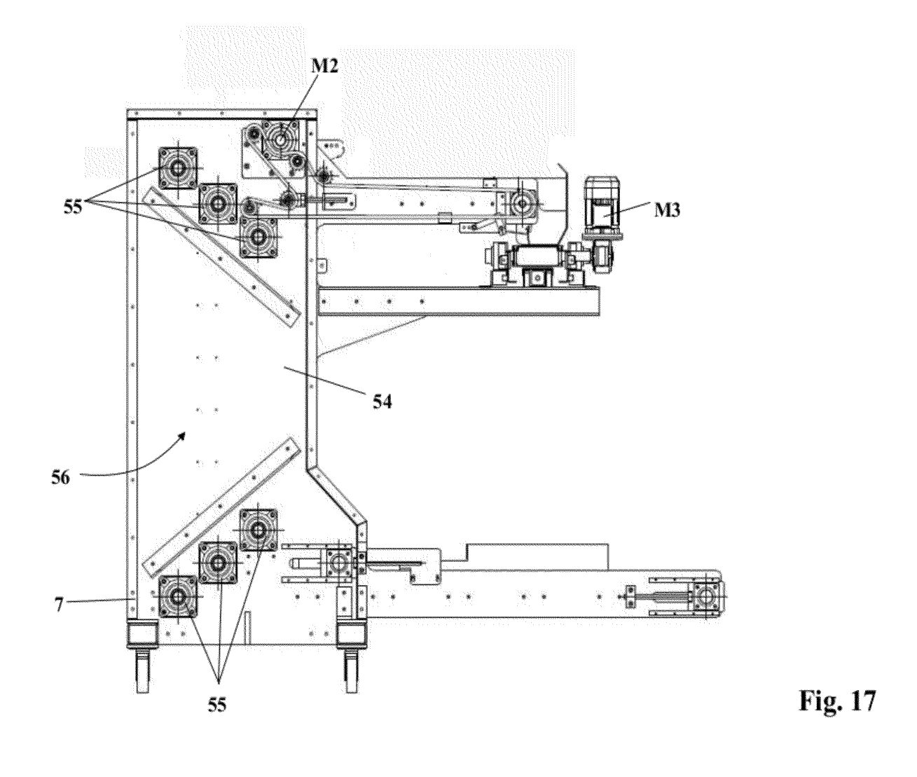

Otherwise, according to the embodiment illustrated in the attached FIGS. 12-17 the upper roller 21 of the first conveyor belt 8 is arranged at a greater height than the return roller 23 so that the first belt 8 exiting from the second return roller 19 is inclined upwards and the lead pieces continue the travel thereof resting on the second horizontal section 12 of the second conveyor belt 9.

According to the embodiment illustrated in the attached FIGS. 1-6 the two belts 8 and 9 are rotated at the same speed each by a respective motor driven roller, i.e. respectively by the first upper end roller 21 and by the second upper end roller 25, respectively by means of a first motor M1 and a second motor M2 with respective reduction gears.

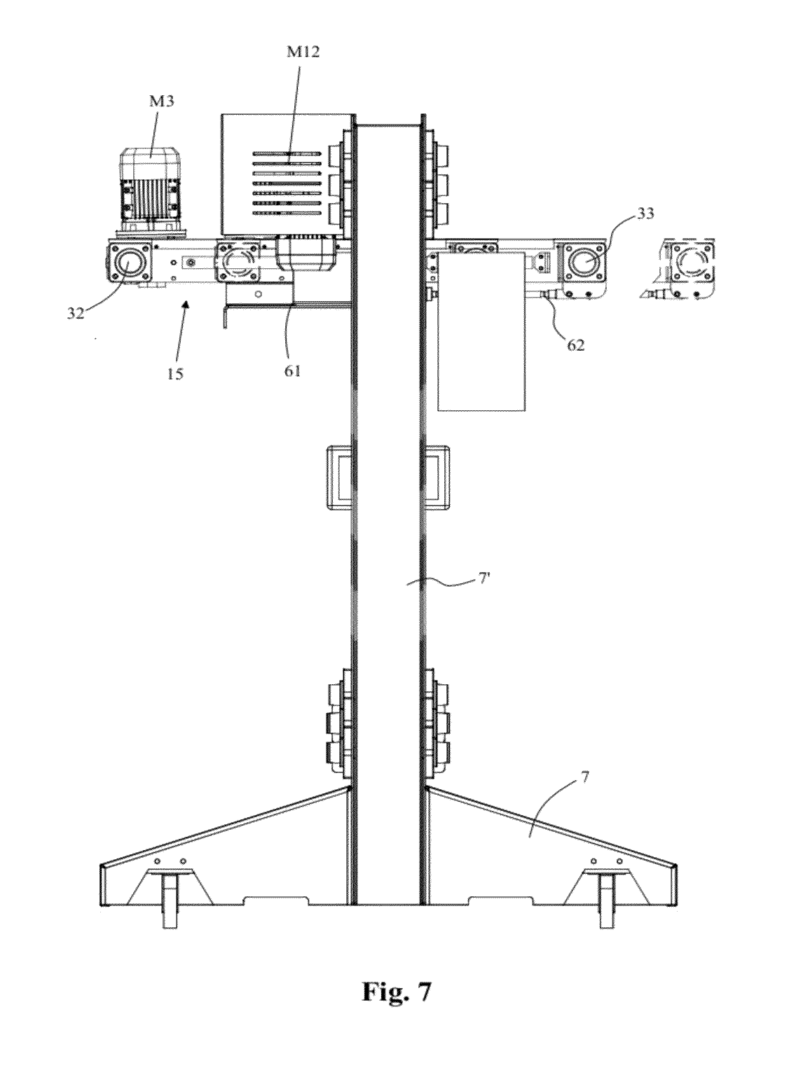

Otherwise, according to the embodiment illustrated in the attached FIGS. 7-11, only one of the two abovementioned rollers may be driven by a motor M12, the other being rotated by the first by means of simple return means obtained for example through flexible transmission means such as a belt.

According to the embodiment illustrated in FIGS. 12-17, the rollers 18-27, on which the first and the second belt 8, 9 are wound, are advantageously cantilevered from a first lateral side 51 of the apparatus 1, horizontally supported by the bearing structure 7. The rollers 18-27 are thus provided with a first free end 52 and a second end 53, constrained to the bearing structure 7. Preferably, the bearing structure 7 is provided with the two sides 54, parallel, spaced from each other and preferably lying vertically. The second end 53 of the rollers 18-27 is supported on the two sides 54 by means of bearings 55. Preferably, each roller is supported by means of two spaced bearings 55 mounted on the two sides 54.

The two sides 54 delimit—between them—a housing compartment 56, which is perimetrally closed by walls 57 so as to seal the compartment towards the external. Within the housing compartment 56 there is housed an electrical panel for shielding from the external environment.

Due to the provision of the cantilevered rollers 18-27 it is possible to maintain the rollers and the belt by simply removing a protection panel 60 for example in form of a grid door.

In particular is it is possible to easily wash—with a water jet—the belts and the rollers, given that they are easily accessible from the side of the apparatus. Furthermore, the electrical panel and other possible control panels housed within the housing compartment 56 remain protected against the water jets during the washing operations.

Preferably, the third conveyor belt 15 is wound in a loop between two third end rollers 32, 33, respectively arranged at the first and the second end of the third conveyor belt 15, and mounted on a framework 34 mechanically connected cantilevered to a column 7′ of the of the bearing structure 7 of the apparatus 1.

The motorisation of the abovementioned third conveyor belt 15 is preferably provided mechanically independent from the one provided for the other two belts 8, 9, for example through a third motor M3 connected to the end roller 32 nearest to the first end 16 of the third conveyor belt 15 which receives the pieces.

According to the embodiment illustrated in FIGS. 1-11, for a better taking over of the pieces between the two belts 8, 9 in the vertical section, as indicated previously, the belts shall also be superimposed even in a portion of the horizontal sections thereof.

More in particular, the first conveyor belt 8 is preferably provided with a third horizontal section 28, arranged to continue the first vertical section 11 thereof, and arranged counterfaced parallel on at least one first portion 29 of the second horizontal section 12 of the second conveyor belt 9 to hold and transport the pieces interposed between the abovementioned second and third horizontal section 28, 29. The latter superimposition of the horizontal layers 12, 28 of the two belts 8, 9 is obtained without interruption with the superimposition of the vertical layers 11, 14 so as to provide a continuous guide for the transport of the pieces.

Furthermore, the second conveyor belt 9 may also be provided with a fourth horizontal section 30, arranged to continue the second vertical section 14 thereof, and arranged counterfaced, parallel on at least one second portion 31 of the first horizontal section 10 of the first conveyor belt 8 to hold and transport pieces interposed between the abovementioned first and fourth horizontal section 10, 30. The latter superimposition of the horizontal layers 10, 30 of the two belts 8, 9 is obtained without interruption with the superimposition of the vertical layers 11, 14 so as to provide a continuous guide for the transporting pieces.

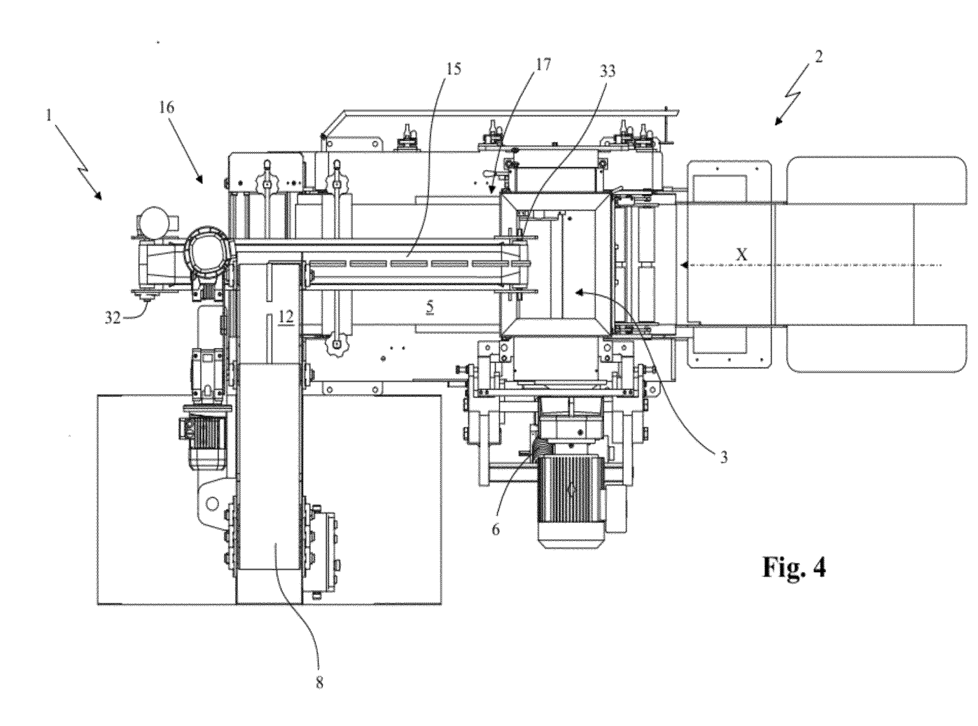

The remaining portions of the two belts 8, 9 are not returned and described in detail and they are advantageously arranged parallel to each other in the respective paths as clearly represented in the attached FIG. 4.

Otherwise, according to the embodiment illustrated in the attached FIGS. 12-17 given that the upper roller 21 of the first conveyor belt 8 is arranged at a greater height than the return roller 23, the third section 28 of the first conveyor belt 8 is not horizontal but it is inclined upwards with respect to the second horizontal section 12 of the second conveyor belt 9.

According to the embodiment of FIGS. 1-6, the framework 34 of the third conveyor belt 15 is supported cantilevered on the support structure 7 by means of a projecting arm 35.

Otherwise and preferably, the framework 34 of the third conveyor belt 15 is supported beneath the second horizontal section 12 of the second conveyor belt 9 by the support structure 7 of the apparatus.

According to an advantageous characteristic of the apparatus 1 subject of the present invention and illustrated in FIGS. 7-11, the third conveyor belt 15 is slidably supported by means of guides 60, fixed to a support framework 61 of the support structure 7, so as to be displaced by means of a second actuator 62 along the direction of development and advancement of the third conveyor belt 15. Thus, the third conveyor belt 15 may be associated or not associated to the second end 17 thereof for releasing the pieces with respect to the opening for loading the hopper 3 of the spreading machine 2. The guides 60, in particular, are engaged in a track 65 projecting from the framework 34.

More in detail, the third conveyor belt 15 is guided supported along the transverse direction of development Y thereof between a first position, in which the first end 16 is at the second upper end roller 25 of the second conveyor belt 9, and a second position, in which the first end 16 thereof is away from the second upper end roller 25 of the second conveyor belt 9.

Such movement allows lifting the hopper 3 of the spreading machine 2 (even solely folded on one side), to allow performing the maintenance operations to allow the replacement of the templates so as to adapt the spreading machine 2, to spread grids of a different shape.

Otherwise, according to the embodiment illustrated in FIGS. 1-7, the third conveyor belt can be easily displaced around an axis to vary the position of the second end 17 thereof with respect to the hopper 3. For such purpose, the projecting arm 35 of the framework of the third conveyor belt 15 is connected to the column 7′ of the bearing structure 7 of the apparatus 1 by means of a hinge 36. For such purpose, a third actuator (not illustrated) mounted on the support structure 7 of the apparatus 1 is suitable to operate on the abovementioned arm 35 to rotate it between a first position, in which the third conveyor belt 15 is extended transverse with respect to the second horizontal section 12 of the second conveyor belt 9 and a second position, in which the third conveyor belt 15 is arranged at an angled position with respect to the first position thereof.

In order to facilitate the detachment of the pieces of paste from the conveyor belts 8, 9, scraper means 40, constituted for example by the inclined blades fixed to the support structure 7, and elastically resting on the surface of the belts to facilitate the detachment of the pieces from the corresponding folds of the belt, are provided for.

Such scraper means 40 are preferably provided for at the ends for releasing the pieces of the second horizontal section 12 of the second conveyor belt 9, i.e. also at the end of the first superimposition portion 29 between the second horizontal section 12 of the second belt 9 and the third horizontal section of the first belt 8.

Furthermore, such scraper means 40 may also be provided for at the outlet end of the conveyor belt 5 of the spreading machine 2 i.e. at the second end 17 of the third conveyor belt 15.

Hence, the invention thus conceived attains the preset objects.

Hence, the device thus conceived attains the preset objects.

Obviously, the shape and configurations of the invention may vary in the practical embodiment thereof with respect to those illustrated above without departing from the scope of protection.

Furthermore, all the details may be replaced by technically equivalent elements and the dimensions, shapes and materials used may vary according to the requirements.

1. Apparatus for recovering pieces of paste of active matter for plates of lead accumulators, intended to be operatively associated with a grid spreading machine of the type equipped with a hopper for loading the paste,
Said apparatus comprising:
a support structure;
at least one first conveyor belt mounted on said support structure, wound in a loop over at least first rollers, and equipped with a first substantially horizontal section, suitable for receiving the pieces from said spreading machine, and with at least one first substantially vertical section, arranged as a continuation of said first horizontal section;
at least one second conveyor belt mounted on said support structure, wound in a loop over at least second rollers, and equipped with a second substantially horizontal section, suitable for giving up the pieces, at a second end roller thereof, in particular to a hopper of said spreading machine, and with at least one second substantially vertical section, arranged as a continuation of said second horizontal section; said at least first and second vertical section, respectively of said first and second conveyor belt, being arranged one on top of the other facing one another, parallel to hold and transport pieces arranged between them, at least from the first horizontal section of said first conveyor belt up to the second horizontal section of said second conveyor belt;
at least one third conveyor belt wound in a loop on third rollers, arranged substantially transversally to the second horizontal section of said second conveyor belt able to receive said pieces at a first end thereof from said second horizontal section and give them up to the hopper of said spreading machine at a second end thereof;
said apparatus being characterised in that:
said first and second conveyor belts are wound on at least two return rollers in common, one of which is a lower one and an upper one, delimiting said first and second vertical section of said conveyor belts;
at least one of said rollers in common is provided with annular cavity, in which there can be extended at least the conveyor belt resting on the roller for housing said lead pieces with the other belt supported thereon.

2. Apparatus for recovering pieces of paste, according to claim 1, characterised in that said first and said second rollers are cantilevered from a first lateral side of said apparatus.

3. Apparatus for recovering pieces of paste, according to claim 2, characterised in that said rollers are provided with a first free end and a second end rotatably supported by said bearing structure.

4. Apparatus for recovering pieces of paste, according to claim 3, characterised in that said bearing structure is provided with the two parallel sides, spaced from each other and with vertical plane; said rollers being supported at said second end on said two sides by means of bearings.

5. Apparatus for recovering pieces of paste, according to claim 4, characterised in that said two sides delimit—between each other—a housing compartment closed perimetrally by walls to seal it towards the external; said housing compartments accommodating the electrical panel of said apparatus to shield it from the external environment.

6. Apparatus for recovering pieces of paste according to claim 1, wherein said first conveyor belt is provided with a third horizontal section arranged as a continuation of its first vertical section and arranged opposite, parallel on at least one portion of the second horizontal section of said second conveyor belt to hold and transport pieces arranged between the aforementioned second and third horizontal section.

7. Apparatus for recovering pieces of paste according to claim 1, wherein said second conveyor belt is provided with a fourth horizontal section arranged as a continuation of its second vertical section and arranged opposite, parallel on at least one portion of the first horizontal section of said first conveyor belt to hold and transport pieces arranged between the aforementioned first and fourth horizontal section.

8. Apparatus for recovering pieces of paste according to claim 1, wherein the first vertical section of said first conveyor belt and the second vertical section of said conveyor belt are wound over a first and second shared return roller.

9. Apparatus for recovering pieces of paste according to claim 1, wherein said first conveyor belt is wound in a loop over first end rollers, one upper and one lower, at least one of which is motorised.

10. Apparatus for recovering pieces of paste according to claim 1, wherein said first conveyor belt is wound in a loop on second end rollers one upper and one lower, at least one of which is motorised.

11. Apparatus for recovering pieces of paste according to claim 1, wherein said third conveyor belt is slidingly mobile along the transversal direction of its extension between a first position, in which its first end is at the second upper end roller of said second conveyor belt and a second position, in which its first end is taken away from the second upper end roller of said second conveyor belt.

12. Apparatus for recovering pieces of paste according to claim 1, wherein said third conveyor belt is rotatably mobile around a substantially vertical axis between a first position, in which said third conveyor belt extends transversally with respect to the second horizontal section of said second conveyor belt and a second position, in which said third conveyor belt is arranged in an angled position with respect to said first position.

13. Apparatus for recovering pieces of paste, according to claim 1, wherein: said first conveyor belt is wound in a loop with parallel paths on first end rollers, one of which upper and one lower, one of which is motor driven; on said first and second return roller, and on a third and a fourth return roller respectively arranged in the vicinity of said first and second return roller and at the same height respectively of said first lower end roller and first upper end roller.

14. Apparatus for recovering pieces of paste, according to claim 1, wherein said second conveyor is wound in a loop with parallel paths on second end rollers, one of which upper and one lower, one of which at least is motor driven; on said first and second return roller, and on a fifth and a sixth return roller respectively arranged in the vicinity of said first and second return roller and at the same height respectively of said second lower end roller and second upper end roller.

15. Apparatus for recovering pieces of paste, according to claim 1, wherein said first conveyor belt is wound in a loop with parallel paths on first end rollers, of which an upper one and a lower one, at least one of which is motor-driven; on said first and second return roller, and on a third and a fourth return roller respectively being arranged near said first and second return roller; said third return roller being arranged at the same height as said first lower end roller; said upper end roller of said first conveyor belt being arranged at a greater height than the fourth return roller so that the first belt exiting from the second return roller is inclined upwards.
